(19) United States
(12) Patent Application Publication
(10) Pub. No.: US 2007/0154598 A1
(43) Pub. Date: Jul. 5, 2007

(54) Process for producing soft-baked pockets comprised of joined fluid-milk infused cereal grains with non-grain fillings

(76) Inventors: Harold W. Zukerman, Northbrook, IL (US); Rachel B. Zukerman, Northbrook, IL (US)

Correspondence Address: Harold W. Zukerman, 4125 W. Yorkshire Lane, Northbrook, IL, 60062, US

(21) Appl. No.: 11/320,290

(22) Filed: Dec. 29, 2005

(51) Int. Cl. A23L 1/36

(52) U.S. Cl. 426/93

(57) ABSTRACT

The present invention relates to a process for making soft-baked breakfast pockets comprised of joined fluid-milk infused cereal grains enclosing a non-grain filling component. When formulated with four full ounces of fluid-milk for each one-ounce of dry cereal grains (the same amount and ratio of fluid-milk to dry cereal used to make a bowl of cereal and fluid-milk breakfast) said soft-baked breakfast pockets of the present invention can be used as a “hand-held” replacement for the traditional cereal, fluid-milk and fruit breakfast that can only be consumed from a bowl with a spoon. In the first step of the process of the present invention, both the non-grain filling component and the fluid-milk infused cereal grains, which are made by infusing 200 to 400 pounds of fluid-milk into each 100 pounds of dry raw cereal grains at temperatures above 180° F., are prepared separately. In the second step of the process, both components are merged into configurations whereby the non-grain filling component is either fully-enclosed or partially-enclosed within joined fluid-milk-infused cereal grains. The soft-baked texture of the joined fluid-milk-infused cereal grains is developed when heated with hot air at temperatures above 300° F.

### BACKGROUND OF THE INVENTION

The present invention relates to a process for making soft-baked breakfast pockets comprised of joined fluid-milk infused cereal grains enclosing a non-grain filling component. When formulated with four full ounces of fluid-milk for each one-ounce of dry cereal grains (the same amount and ratio of fluid-milk to dry cereal used to make a bowl of cereal and fluid-milk breakfast) said soft-baked breakfast pockets of the present invention can be used as a “hand-held” replacement for the traditional cereal, fluid-milk and fruit breakfast that can only be consumed from a bowl with a spoon.

The prior art teaches how to make intermediate moisture cereal pocket products having high-sugar fruit fillings enclosed within shells comprised of finely-milled wheat flour, sugar syrup and glycerin. Said intermediate moisture cereal pocket products cannot be used as a replacement for a traditional cereal and fluid-milk breakfast because in order to be shelf-stable they have to be formulated with high levels of sugar syrups and glycerin instead of fluid milk. The intermediate moisture cereal pocket products' preservation system requires having a water activity (Aw) below 0.85. If the shell-component of the intermediate moisture pocket product was formulated with large amounts of fluid-milk, their water activity (Aw) will increase above 0.85 and cause said intermediate moisture cereal pocket product to spoil when stored at room temperature.

U.S. Pat. No. 5,525,366 Zukerman et al teaches a process for making two-component rice products having shells comprised of cooked rice grains

The prior art also teaches how to make bread-dough pocket products from finely-milled wheat flour and water. The following is a partial list of the many bread-dough pocket-like products made by kneading wheat flour with water: stuffed pocket sandwiches, stuffed pita-pocket sandwiches, stuffed subways sandwiches, fat-fried egg rolls, pizza rolls, and filled-pasta products such as ravioli, burritos, pasties, blintzes and kreplach. Bread-dough pocket products are made by kneading finely-milled wheat flour with water to produce a wheat gluten dough which has special unique properties such as a) elasticity wherein thin wheat-gluten-dough sheets can be stretched without tearing; b) uncooked wheat-gluten-dough irreversibly firms when heated; c) heat-gluten-dough sheets won't tear easily because they are structurally very strong, and d) the gluten structure of the wheat-gluten-dough is able to retain gases so the expansion of said wheat-dough gluten structure can be controlled when baked.

The prior art, U.S. Pat. No. 6,103,283, Zukerman et al. teaches a process for producing hand-held cereal and milk food products having “cereal-grain” interiors.

The prior art also teaches how to make the traditional breakfast of cereal and fluid-milk by combining one ounce of dry, RTE (Ready-To-Eat) cereal pieces such as flakes, circles or squares with four ounces of refrigerated fluid-milk into a bowl. This combination becomes “fluid” and therefore can only be consumed from a bowl with a spoon.

### BRIEF SUMMARY OF THE INVENTION

The present invention relates to a process for making soft-baked breakfast pockets comprised of joined fluid-milk infused cereal grains enclosing a non-grain filling component. When formulated with four full ounces of fluid-milk for each one-ounce of dry cereal grains, said soft-baked breakfast pockets of the present invention can be used as a “hand-held” replacement for the traditional cereal, fluid-milk and fruit breakfast that has to be consumed from a bowl with a spoon.

In the first step of the process of the present invention, both the filling component, which is substantially free of cereal grains, and the fluid-milk-infused cereal grains are prepared separately. The fluid-milk-infused cereal grains are made by first dispersing starch-complexing agents into the fluid-infusion-milk. Then, food colors, sweeteners, food particles and food flavors can also be added to the fluid-infusion-milk if desired. The fluid-infusion-milk is then heated and infused into the cereal grains at the ratio of about two hundred to four hundred pounds of fluid-milk for each one hundred pounds of dry, raw cereal grains at temperatures over 180° F. in a steam-jacketed kettle equipped with scraper agitators that gently mix the grains while scraping the sides of the kettle. During the fluid-milk-infusion process, when most of the fluid-milk is infused into the individual cereal grains, said grains develop a soft-moist to soft-wet texture and “sticky” grain surfaces. In the second step of the process, both components are merged into configurations wherein the non-grain filling component is either fully-enclosed or partially-enclosed within the joined fluid-milk-infused cereal grains. The soft-baked texture of the joined fluid-milk-infused cereal grains is developed when the formed pocket-units are heated with hot air at temperatures above 300° F.

It is an object of the present invention to provide a process for making soft-baked breakfast pockets comprised of joined fluid-milk-infused cereal grains “completely-enclosing” non-grain fillings; said breakfast pockets can be used as a “hand-held” replacement for the traditional cereal, fluid-milk and fruit breakfast that is “fluid” and has to be consumed from a bowl with a spoon.

It is an another object of the present invention to provide a process for making soft-baked (open-face) breakfast pockets comprised of joined fluid-milk-infused cereal grains “partially-enclosing” non-grain fillings; said soft-baked (open-face) breakfast pockets can be used as a “hand-held” replacement for the traditional cereal, fluid-milk and fruit breakfast that is “fluid” and has to be consumed from a bowl with a spoon.

### BRIEF DESCRIPTION OF THE DRAWINGS

FIG. 1A illustrates an example of an unfilled soft-baked (open-face) breakfast pocket comprised of joined fluid-milk-infused cereal grains (1) having a concave depression (3). Said unfilled, soft-baked (open-face) breakfast pocket is made in accordance with the process of the present invention

FIG. 1B illustrates an example of a soft-baked (open-face) breakfast pocket comprised of joined fluid-milk-infused cereal grains (1) which “partially-enclose” a filling component substantially free of cereal grains (2). Said soft-baked (open-face) breakfast pocket is made in accordance with the process of the present invention.

FIG. 2 illustrates an example of a soft-baked breakfast pocket comprised of joined fluid-milk-infused cereal grains (1) which “completely-enclose” a filling component substantially free of cereal grains (2). Said soft-baked breakfast pocket is made in accordance with the process of the present invention.

FIG. 3 illustrates another example of a soft-baked breakfast pocket comprised of joined fluid-milk-infused cereal grains (1) which “completely-enclose”” a filling component substantially free of cereal grains (2). Said soft-baked breakfast pocket is made in accordance with the process of the present invention.

### DETAILED DESCRIPTION OF THE PREFERRED EMBODIMENT

The present invention relates to a process for making soft-baked breakfast pockets comprised of joined fluid-milk infused cereal grains enclosing a non-grain filling component. When formulated with four full ounces of fluid-milk for each one-ounce of dry cereal grains, said soft-baked breakfast pockets of the present invention can be used as a “hand-held” replacement for the traditional cereal, fluid-milk and fruit breakfast that has to be consumed from a bowl with a spoon.

In the first step of the process, both the filling component, which is substantially free of cereal grains, and the fluid-milk-infused cereal grains are prepared separately. The fluid-milk-infused cereal grains are made by first dispersing starch-complexing agents into the fluid-infusion-milk. Then, food colors, sweeteners, food particles and food flavors can also be added to said fluid-infusion-milk if desired. The fluid-infusion-milk is infused into the cereal grains at the ratio of about two hundred to four hundred pounds of fluid-milk for each one hundred pounds of dry, raw cereal grains at temperatures over 180° F. in a steam-jacketed kettle equipped with scraper agitators that gently mix the grains while scraping the sides of the kettle. During the fluid-milk-infusion process, the individual cereal grains develop a soft-moist to soft-wet texture and their surfaces develop a “sticky cohesiveness” from both the milk proteins of the fluid-milk and the soluble starch of the cereal grains.

In the process of the present invention, the infusion of fluid-milk into the cereal grains and/or modified cereal grains does not occur instantaneously. It takes between twenty minutes to an hour to infuse all of the hot fluid-infusion-milk from the surface of the grains into their centers. The fluid-milk infusion time depends on the genre and modification of the cereal grains, i.e. oats, rice or wheat, or grain combinations thereof, and the temperature of the fluid-infusion-milk. The hot fluid-milk-infused cereal grains are discharged from the infusion kettles while said grains are still flowable and before all the infusing fluid-milk has absorbed into the grains' centers. If the milk-infusing grains remain in the infusion-kettle too long, they could absorb all of the very large amounts of fluid-milk and become so firmly joined together that it is difficult to remove them from the kettle. For that reason, said soft, wet and still absorbing cereal grains should be discharged from the infusion-kettle onto a non-shear conveying system so they are able to continue absorbing their adhering hot, fluid-infusion milk into their centers as they are moved to the forming equipment.

The infusion of the fluid-milk into the cereal grains can be accomplished with continuous steam-jacketed or steam-injection-cookers, or stationary tilt-type steam-jacketed kettles at either atmospheric pressure or at higher than atmospheric pressure and with a non-shear conveying system. Cookers, kettles and non-shear conveying systems are well-known in the art and readily available in the marketplace.

In the process of the present invention, whole cereal grains and/or pieces of whole cereal grains and/or modified cereal grains selected from the group consisting of: rice, wheat, corn, or oats or grain combinations hereinafter are sometimes collectively referred to as “grains”. Modified cereal grains are made by flattening whole cereal grains into thick flakes with rolls, cutting cereal grns with steel cutters, pre-cooking cereal grains, and combinations thereof. Modified cereal grains can be used in the process of the present invention because they are able to be infused with hot fluid-milk faster than whole cereal grains. In the finished product, fluid-milk-infused modified cereal grains have a similar texture and appearance to fluid-milk-infused whole cereal grains.

Starch-complexing the cereal grains during the fluid-milk infusion step can be achieved with starch-complexing agents such as monoglycerides and glycerin. Starch-complexing agents are useful for this application because they prevent starch retrogradation, improve the product's freeze-thaw stability properties, and provide sufficient lubricity to prevent the sticky cereal grains from becoming attached to the process equipment. Other starch-complexing agents that can be used to complex the starch of the fluid-milk infused cereal grains can be selected from the group consisting of calcium, stearoyl-2-lactylate, sodium stearoyl-fumarate, sucrose fatty acids and succinylate monoglycerides, and combinations thereof.

The fluid infusion-milk that is infused into the grains is selected from the group consisting of: full-fat fluid-milk, chocolate milk, fluid-milk treated with cultures, low-fat fluid-milk, fat-free-fluid-milk, fluid-milk developed by combining water with concentrated milk, powdered milk whey, powdered milk proteins, condensed milk, dry milk solids, or fluid-milk further diluted with water and combinations thereof.

Sweeteners used in the process of the present invention provide the fluid-milk infused cereal grains with a sweet taste. Said sweeteners can be selected from the group consisting of: Aspartame, Sucralose, sucrose, brown sugar, molasses, dextrose, corn syrup, fructose, and honey and combinations thereof.

Flavors used in the process of the present invention provide the fluid-milk infused cereal grains with its flavor profile. Natural and artificial flavors can be selected from the group consisting of: vanilla, chocolate, malt, butter; spices selected from the group consisting of cinnamon, ginger, allspice, nutmeg; and fruit flavors and fruit particles selected from the group consisting of: cherry, strawberry, raisins, raspberry, apple, peach and combinations thereof.

The soft-baked pockets' filling which is substantially free of cereal grains is hereinafter referred to as the “filling-component”. During the first step of the process, said filling-component is prepared separately and moved to the forming equipment in separate containers or by separate conveying systems. Said filling-component can be comprised of foods such as: diced and sliced fruit selected from the group consisting of cherries, strawberries, raspberries, apples, peaches or vegetables, or breakfast combinations such as ham, bacon, cheese, and eggs. When said filling-component is prepared, excess fluids should be thickened with binders such as starch and/or gums so the extra fluid from filling-component will not be able to soak into the fluid-milk-infused cereal grains when the two-component pocket products are formed.

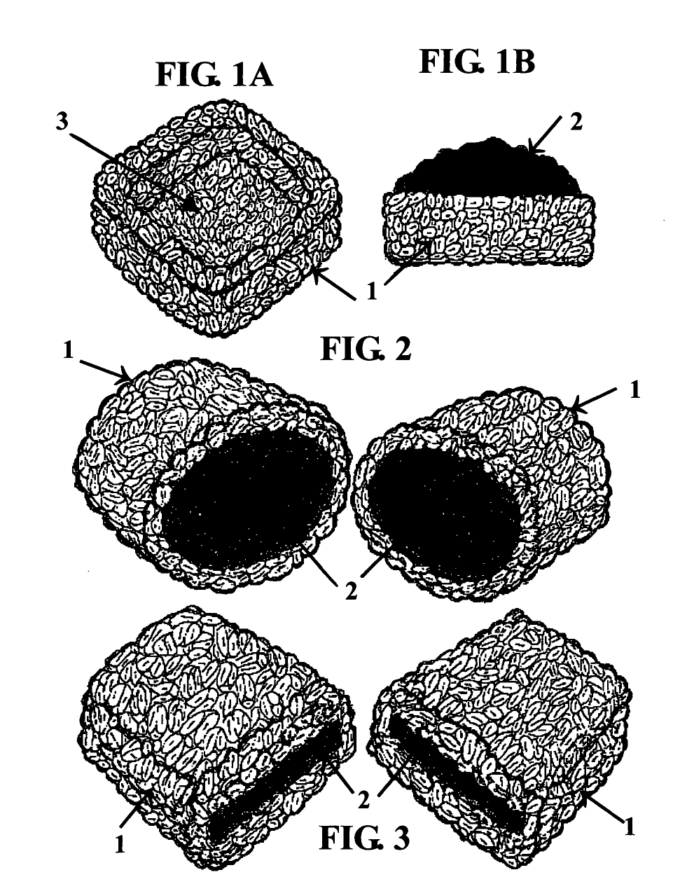

In the second step of the process, both the fluid-milk-infused cereal grains and the filling-component are merged into pocket configurations in which said filling-component is either “completely-enclosed” or “partially-enclosed” within the joined fluid-milk-infused cereal grains. “Completely-enclosed” pockets are illustrated in FIG. 2 and FIG. 3. The term “partially enclosed” pockets is hereafter referred to as “open-face pockets” with examples illustrated in FIG. 1B.

One technique for forming completely-enclosed pockets is by depositing a continuous grain-sheet comprised of flavored, joined, fluid-milk-infused cereal grains (approximately ⅜ inch thick) onto a belt-conveyor where said-sheet is then compressed with multiple dies which form multiple depressions spaced about one-inch apart from each other. This step also adjusts the height of said grain-sheet and also more firmly binds the individual sticky-surfaced grains to each other. If desired, a non-stick film can be inserted between the dies and the continuous grain-sheet to prevent said dies from sticking to said grain-sheet. The multiple depressions developed in the continuous grain-sheet are then filled with the filling-component. A second continuous grain-sheet is then layered over the filling-component enclosing the filling-component between the two continuous grain-sheets. Both grain-sheets are then compressed and sealed to each other at the edges of the grain walls thereby completely enclosing the filling-component within. Rotary and guillotine cutters are then used to cut the continuous two-layer grain-sheets with enclosed fillings at their sealed ends thereby forming individual enclosed pockets.

Another technique for forming completely-enclosed pockets is by co-extrusion. In this forming technique, the fluid-milk-infused cereal grains and the filling-component are separately moved to the co-extrusion system with non-shear conveying or pumping systems. Then, said co-extrusion system forms the enclosed-pockets whereby the filling component in completely enclosed within the fluid-milk-infused cereal grains, as illustrated in FIG. 2 and FIG. 3, without destroying the appearance and texture of the said joined fluid-milk-infused cereal grains.

There are also several forming techniques for making partially-enclosed, open-face pockets comprised of fluid-milk-infused cereal grains partially-enclosing the filling component. Example is illustrated in FIG. 1B. One technique for forming open-face pockets is by depositing a continuous grain-sheet comprised of flavored, joined, fluid-milk-infused cereal grains (approximately ⅜ inch thick) onto a belt-conveyor where said-sheet is then compressed with multiple dies which form multiple depressions spaced about one-inch apart from each other. This step also adjusts the height of said grain-sheet and also more firmly binds the individual sticky-surfaced grains to each other. If desired, a non-stick film can be inserted between the dies and the continuous grain-sheet to prevent said dies from sticking to said grain-sheet. Rotary and guillotine cutters are then used to cut the continuous grain-sheet at the center of the grain-walls surrounding said depressions, thereby forming individual unfilled, open-face pockets having approximately one half-inch thick grain walls and bottom, as illustrated in (1) of FIG. 1A. Said unfilled open-face pockets are then oven-baked with hot air at temperatures above 300 F to develop the soft-baked texture of the pockets' fluid-milk-infused cereal grains. Then the soft-baked, unfilled, open-face pockets are filled with the filling component.

Another technique for forming partially enclosed open-face pockets is by depositing a continuous grain-sheet comprised of flavored, joined, fluid-milk-infused cereal grains (approximately ⅜ inch thick) onto a belt-conveyor where said-sheet is then compressed with multiple dies which form multiple depressions spaced about one-inch apart from each other. This step also adjusts the height of said grain-sheet and also more firmly binds the individual sticky-surfaced grains to each other. If desired, a non-stick film can be inserted between the dies and the continuous grain-sheet to prevent said dies from sticking to said grain-sheet. The multiple depressions developed in the continuous grain-sheet are then filled with the filling-component. Rotary and guillotine cutters are then used to cut the continuous grain-sheet at the center of the grain-walls surrounding said filled depressions, thereby forming individual filled, open-face pockets having approximately one half-inch thick grain walls and bottom. Said filled open-face pockets as illustrated in FIG. 1B are comprised of fluid-milk infused cereal grains (1) partially enclosing the filling-component (2).

In the third step of the process of the present invention the pockets comprised of fluid-milk infused cereal grains and filling components are oven-baked at temperatures above 300° F. to develop the soft-baked texture of the pockets' fluid-milk infused cereal grains.

The soft-baked breakfast pockets can be frozen and stored frozen. Freezing can be done with either: cold air, liquid nitrogen, or liquid carbon dioxide. It is desirable to freeze the units to about 0° F. The freezing process and freezers suitable for this operation are well-known in the art and are commercially available.

The following two examples will further illustrate the invention, but it is not intended that the invention be limited to the details set forth therein:

### EXAMPLE 1

### Process for Producing Soft-Baked “Completely-Enclosed” Pockets Comprised of Joined Fluid-Milk-Infused Rice and Oat Grains Completely Enclosing a Diced Apple Filling

Formula: Soft-Baked Pockets Made With
Fluid-Milk-Infused Rice and Oats.

| Ingredients | Percent |
|---|---|
| Full-Fat Fluid-Milk | 70.00 |
| Rice Grains | 10.00 |
| Thick Oat Flakes | 10.00 |
| Sucrose | 6.00 |
| Brown Sugar | 2.00 |
| Apple Cinnamon Flavor | 1.00 |
| Salt | 0.75 |
| Monoglyceride-Lecithin Blend | 0.25 |
| Total: | 100.00 |

### EXAMPLE 1

### Process

In the first step of the process, the monoglyceride-lecithin blend is dispersed into full-fat fluid-milk with a Lightning Mixer. Sugar, salt and flavor are then added to the fluid-milk to produce a fluid-milk infusing solution which is infused into the cereal grains at about 210® F. A separate kettle is used to prepare the diced-apple filling component comprised of diced apples, sugar and starch thickener.

In the second step of the process, pockets comprised of joined fluid-milk-infused cereal grains with completely enclosed filling components, as illustrated in FIG. 2 and FIG. 3, are formed by the following procedure: a continuous ⅜ inch thick, flavored, joined, fluid-milk infused cereal grain-sheet is first deposited onto a belt-conveyor. Said grain-sheet is then compressed with multiple dies to a) adjust the height of said grain-sheet b) form multiple concave depressions in said grain-sheet (spaced about one inch apart from each other) and c) bind the individual grains in said grain-sheet more firmly to each other. (A non-stick film is inserted between said dies and said grain-sheet when said depressions are developed in said grain-sheet. The multiple concave depressions in said grain-sheet are then filled with the diced-apple filling before a second continuous ⅜ inch thick, flavored fluid-milk infused cereal grain-sheet is layered on top. Then, the two grain-sheets with the filling component in-between are sealed to each other with compression sealers to completely enclose the diced-apple fillings before said grain-sheets are cut into individual units and then baked at temperatures above about 300° F. to develop the soft-baked texture of the pockets' fluid-milk infused cereal grains. The soft-baked pockets are then frozen and stored frozen.

### EXAMPLE 2

### Process for Producing Soft-Baked “Open-Face” Pockets, Comprised of Joined Fluid-Milk-Infused Rice and Oat Grains Partially Enclosing a Diced Apple Filling

Formula: Soft-Baked (Open-Face) Pockets
Made With Fluid-Milk-Infused Oats.

| Ingredients | Percent |
|---|---|
| Fat-Free Fluid-Milk | 65.00 |
| Thick Oat Flakes | 25.00 |
| Sucrose | 6.00 |
| Brown Sugar | 2.00 |
| Apple Cinnamon Flavor | 1.00 |
| Salt | 0.75 |
| Monoglyceride-Lecithin Blend | 0.25 |
| Total: | 100.00 |

Note:
The fluid-milk is prepared by dissolving dry milk solids in water.

### EXAMPLE 2

### Process

Soft-baked, open-face pockets (as illustrated in FIG. 1B) are comprised of joined fluid-milk-infused cereal grains (1) which “partially-enclose” a non-gain filling (2). joined to each other. In the first step of the process, the fluid-milk is prepared by dissolving dry milk solids in water. Then, a monoglyceride-lecithin blend is dispersed into the fluid-milk with a Lightning Mixer. Sugar, salt and flavor are then added to the fluid-milk to produce a fluid-milk infusing solution which is then infused into the cereal grains at about 210° F. A separate kettle is used to prepare the diced-apple filling component comprised of diced apples, sugar and starch thickener.

In the second step of the process, a continuous ⅜ inch thick, flavored, joined, fluid-milk infused cereal grain-sheet is first deposited onto a belt-conveyor. Said grain-sheet is then compressed with multiple dies to a) adjust the height of said grain-sheet b) form multiple concave depressions in said grain-sheet (spaced about one inch apart from each other) and c) bind the individual grains in said grain-sheet more firmly to each other. A non-stick film is inserted between said dies and said grain-sheet during the formation of the concave depressions in said grain-sheet. The grain-sheet is then cut into unfilled open-face pocket units as illustrated in FIG. 1A having concave depressions (3) in said open-face pocket. The unfilled open-face pockets are then baked in a convection oven at 400° F. to develop the soft-baked texture of the fluid-milk infused cereal grains. Finally, the concave depressions of the open-face pockets are filled with the diced-apple filling, frozen and stored frozen.

It is to be understood that the above described process and the above examples are simply illustrative of the application of principles of the invention and many other modifications may be made without departing from the spirit and scope of the invention. The embodiments of the invention in which an exclusive property or privilege is claimed are defined as follows:

We claim:

1. A process for producing soft-baked food products whereby joined fluid-milk-infused cereal grains completely enclose a filling-component substantially free of cereal grains; said process comprising the steps of:
a) preparing fluid-milk-infused cereal grains by infusing 200 to 400 pounds of fluid-milk into each one hundred pounds of cereal grains at temperatures above 180° F. while separately preparing a filling-component which is substantially free of cereal grains;
b) forming units wherein the filling-component of 1a is completely enclosed within the joined fluid-milk-infused cereal grains;
c) oven-baking the units formed in 1b at temperatures above 300° F. to develop the soft-baked texture of the fluid-milk infused cereal grains.

2. The process of claim 1 wherein the whole cereal grains and modified cereal grains are selected from the group consisting of: oats, wheat, rice, corn and combinations thereof.

3. The process set forth in claim 1 wherein the fluid-milk is selected from the group consisting of: full-fat fluid-milk, chocolate milk, fluid-milk treated with cultures, low-fat fluid-milk, fat-free-fluid-milk, fluid-milk developed by combining water with concentrated milk, powdered milk, whey, powdered milk proteins, condensed milk, fluid-milk further diluted with water and combinations thereof.

4. The process of claim 1 wherein starch complexing agents, food colors, food particles, flavors and sweeteners are added to the fluid-milk before it is infused into the cereal grains.

5. The process of claim 1 wherein the fluid-milk infused cereal grains are discharged from the infusion-kettle before said cereal grains become firmly-joined to each other.

6. The process of claim 1 wherein the fluid-milk-infused cereal grains and the filling-component are formed into shaped units with non-shear forming equipment in a manner that does not destroy the appearance and texture of said fluid-milk-infused grains.

7. The process of claim 1 wherein units are formed by: depositing a continuous grain-sheet comprised of fluid-milk infused cereal grains; developing concave depressions in said grain-sheet; depositing a filling-component into said concave depressions; layering a second continuous grain-sheet comprised of fluid-milk-infused cereal grains on top of the first grain-sheet; sealing the two grain-sheets which completely enclose the filling component; and then cutting the two grain-sheets with enclosed filling-components into units.

8. The process of claim 1 wherein units comprised of joined fluid-milk-infused cereal grains completely enclosing filling components substantially free of cereal grains are formed by co-extrusion with non-shear pumping systems that form said completely enclosed units without destroying the appearance and texture of the joined fluid-milk-infused cereal grains.

9. The process of claim 1 which further comprises the step of freezing the soft-baked units comprised of joined fluid-milk-infused cereal grains completely enclosing fillings that are substantially free of cereal grains.

10. A process for producing soft-baked food products whereby joined fluid-milk-infused cereal grains partially enclose a filling-component substantially free of cereal grains; said process comprising the steps of:
a) preparing fluid-milk-infused cereal grains by infusing 200 to 400 pounds of fluid-milk into each one hundred pounds of cereal grains at temperatures above 180° F. while separately preparing a filling-component which is substantially free of cereal grains;
b) forming the fluid-milk infused cereal grains of 10a) into shaped units that have a concave depression;
c) oven-baking the shaped units of 10b) with hot air at temperatures above 300° F. to develop the soft-baked texture of the joined fluid-milk-infused cereal grains;
d) filling the concave depressions in the soft-baked units of 10c with a filling-component that is substantially free of cereal grains.

11. The process of claim 10 wherein cereal grains and modified cereal grains are selected from the group consisting of: oats, wheat, rice, corn and combinations thereof.

12. The process of claim 10 wherein food colors, starch-complexing agents, flavors, food particles, and sweeteners are added to the fluid-milk before it is infused into the cereal grains.

13. The process set forth in claim 10 wherein the fluid-milk is selected from the group consisting of: full-fat fluid-milk, chocolate milk, fluid-milk treated with cultures, low-fat fluid-milk, fat-free-fluid-milk, fluid-milk developed by combining water with concentrated milk, powdered milk, whey, powdered milk proteins, condensed milk, fluid-milk further diluted with water and combinations thereof.

14. The process of claim 10 wherein the units are formed by first depositing a continuous grain-sheet comprised of fluid-milk-infused cereal grains, depressing said grain-sheet with multiple dies which form multiple-concave depressions spaced about one inch apart; cutting said grain-sheet with multiple concave depressions into individual units with cutters; oven-baking said units with concave depressions at temperatures above 300° F. to develop the soft-baked texture of the fluid-milk-infused cereal grains; and then filling the concave depressions in said soft-baked units with a filling-component substantially free of cereal grains.

15. The process of claim 10 which further comprises the step of freezing the soft-baked units comprised of fluid-milk-infused cereal grains and filling-components.

16. A process for producing soft-baked products comprised of joined fluid-milk-infused cereal grains partially enclosing a filling component substantially free of cereal grains; said process comprising the steps of:
a) preparing fluid-milk-infused cereal grains by infusing 200 to 400 pounds of fluid-milk into each one hundred pounds of cereal grains at temperatures above 180° F. while separately preparing a filling component which is substantially free of cereal grains;
b) forming units from the two-components prepared in 16a whereby the filling component which is substantially free of cereal grains is partially enclosed within the joined fluid-milk-infused cereal grains.
c) oven-baking the units formed in 16b at temperatures above 300° F. to develop the soft-baked texture of the fluid-milk infused cereal grains.

17. The process of claim 16 wherein cereal grains and modified cereal grains are selected from the group consisting of: oats, wheat, rice, corn and combinations thereof.

18. The process set forth in claim 16 wherein the fluid-milk is selected from the group consisting of: full-fat fluid-milk, chocolate milk, fluid-milk treated with cultures, low-fat fluid-milk, fat-free-fluid-milk, fluid-milk developed by combining water with concentrated milk, powdered milk, whey, powdered milk proteins, condensed milk, fluid-milk diluted further with water and combinations thereof.

19. The process of claim 16 wherein food colors, starch-complexing agents, flavors, food particles and sweeteners are added to the fluid-milk before it is infused into the cereal grains.

20. The process of claim 16 which further comprises the step of freezing the soft-baked units comprised of fluid-milk-infused cereal grains partially enclosing the filling components substantially free of cereal grains.
